(19) United States
(12) Patent Application Publication
(10) Pub. No.: US 2026/0336926 A1
(43) Pub. Date: Oct. 29, 2026

(54) REPLACEMENT ANCHORING SYSTEMS

(71) Applicant: Frazier Industrial Company, Long Valley, NJ (US)

(72) Inventor: Mark Boehnke, Waterloo, NY (US)

(21) Appl. No.: 19/186,908

(22) Filed: Apr. 23, 2025

(51) Int. Cl. B65G 1/04; A47B 91/08

(52) U.S. Cl. CPC B65G 1/04; A47B 91/08

(57) ABSTRACT

A replacement anchoring plate system for storage rack systems is provided. The system includes a replacement anchoring plate with a substantially perpendicular portion fixed to a vertical column and a horizontal portion extending over a pre-existing base support plate. One or more anchoring shims may be utilized to ensure proper fit and stability. The system aims to restore the integrity of storage rack anchoring hardware that has been compromised due to damage from storage vehicles, providing a solution that allows for easy replacement while maintaining safety and operational efficiency within the warehouse environment. The system can also be integrated into existing anchor guards, further enhancing its protective capabilities.

### FIELD

The present disclosure relates to storage systems and more particularly to replacing anchoring systems in these storage systems.

### BACKGROUND

Anchoring systems are utilized in storage rack systems, particularly within warehouses where pallet storage occurs. In many warehouse environments, extensive rack systems are established to facilitate the efficient storage of pallets and other inventory. These systems often rely on anchoring hardware, such as bolts, nuts and washers, to secure the vertical columns of the racks to the ground. Unfortunately, the anchoring hardware is exposed to potential damage from, for example, forklifts and/or pallets that may have fallen, which may inadvertently collide with components of the racking system.

Pallets of goods are stored on multi-level warehouse storage racks with vertically aligned gaps therebetween to define aisles for a moving storage vehicle, i.e., a pallet truck, to store pallets on the various levels and retrieve the pallets therefrom.

The storage racks often employ four, five or more vertically aligned levels of storage rack bays, each of which may be many pallets deep. Some systems, for example, may be 10, 20, 30 or more pallets deep. Such racks are typically formed with vertical columns, which support horizontal rails running lengthwise from the front of a storage bay row to the rear of each bay.

During operations in warehouse aisles, it is not uncommon for forklifts to strike the anchoring hardware, leading to damage that may compromise the structural stability of the storage rack system. When the existing anchoring hardware becomes damaged, users might attempt to remove it. If the hardware is stubbornly secured or damaged beyond easy removal, users might resort to cutting the hardware flush with the base plate, potentially leaving the rest of the structural system vulnerable.

Although anchoring guards are occasionally employed to protect anchoring hardware, these guards themselves may be susceptible to damage or degradation over time. These instances underscore a significant need for effective replacement anchoring systems that may be easily deployed when existing hardware is compromised. Such systems should not only restore integrity to the storage rack system but should also be compatible with existing anchoring guards, even though such integrated use may not be the most common scenario.

Lastly, any replacement anchoring system should not cause any disruption to neighboring storage racks.

### SUMMARY

An aspect of the present disclosure aims to provide a replacement anchoring plate system that offers a straightforward solution for restoring the anchoring mechanism of storage rack systems where the original hardware has been damaged. The system includes a designed replacement anchoring plate that may be easily affixed to the existing structural components, thereby ensuring that the storage racks remain securely anchored to the ground.

Specifically, an aspect of the present disclosure encompasses a replacement anchoring plate featuring a substantially perpendicular portion that may be fixed to the lower section of a column, with a horizontal portion extending over a section of the existing base support plate. This design offers adaptability, allowing for the integration of additional components, such as anchoring shims, to enhance stabilization and support.

The replacement anchoring plate system may include multiple anchoring plates installed on opposite sides of a column, allowing for a robust and symmetrical restoration of anchoring integrity. Moreover, the configuration of the system may accommodate various dimensional requirements based on different anchoring hardware specifications and may include features to facilitate easy drilling and attachment of hardware.

### BRIEF DESCRIPTION OF THE DRAWINGS

Figures are included to illustrate certain aspects of the present disclosure and should not be viewed as exclusive embodiments. The subject matter disclosed is capable of considerable modifications, alterations, combinations, and equivalents in form and function, as will occur to one having ordinary skill in the art and having the benefit of this disclosure.

FIG. 1 is a side view of the replacement anchoring system.

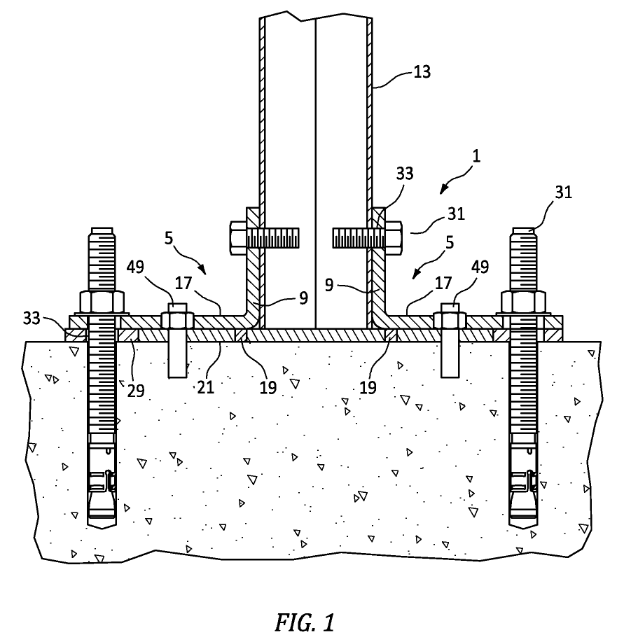

FIG. 2 is a top plan view of the replacement anchoring system.

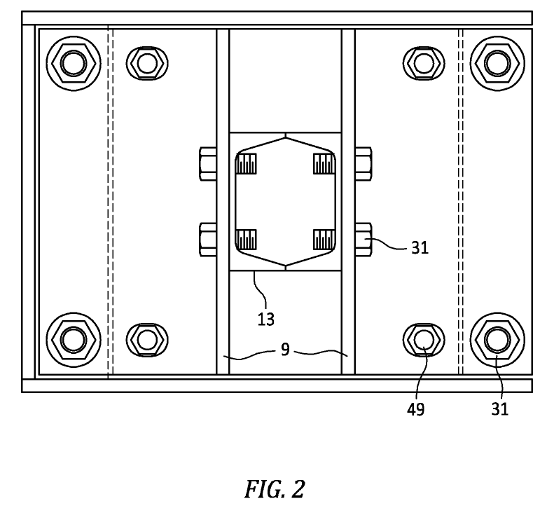

FIG. 3 is a top left perspective view of the replacement anchoring system.

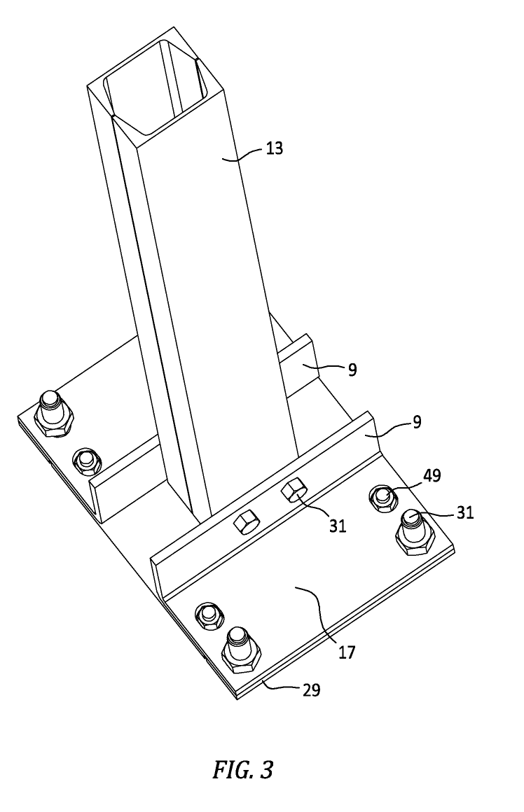

FIG. 4. Is a top left perspective view of a replacement anchoring system within an anchor guard.

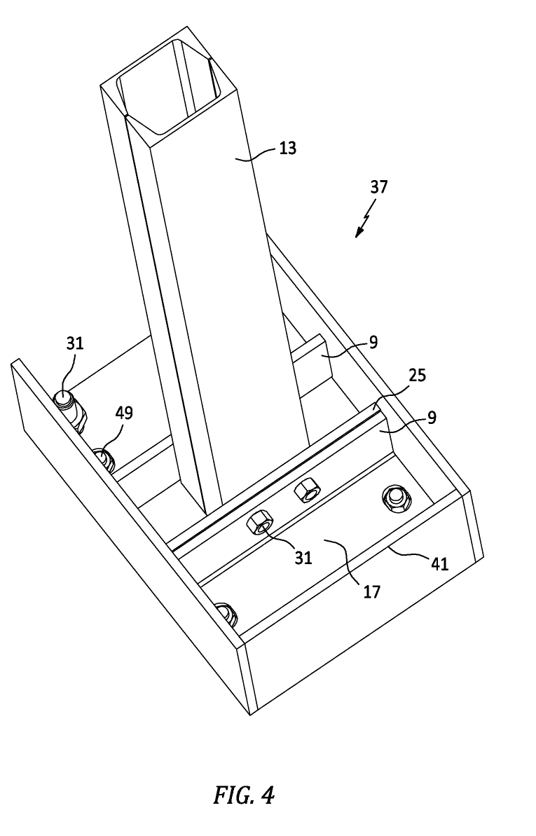

### DETAILED DESCRIPTION

While various embodiments of the systems have been described, these embodiments are illustrative and in no way limit the scope of the described systems. Those having skill in the relevant art may effect changes to form and details of the described systems without departing from the broadest scope of the described systems. Thus, the scope of the systems described herein should not be limited by any of the illustrative embodiments and should be defined in accordance with the accompanying claims and their equivalents.

Referring to the figures, the replacement anchoring plate system 1 for storage rack systems includes a replacement anchoring plate 5. This anchoring plate includes a substantially perpendicular portion 9 designed to be fixed securely to the lower portion of a vertical column 13. The horizontal portion 17 of the anchoring plate extends over an existing base support plate 21, effectively bridging the gap caused by damaged hardware.

In an embodiment, the substantially perpendicular portion 9 is anchored directly to the column 13, reinforcing the structural integrity of the rack. To improve fitment and stability, an anchoring shim 25 may be introduced between the perpendicular portion 9 and the column 13, allowing for additional adjustments based on existing conditions. A second anchoring shim 29 may be positioned between the horizontal portion and the existing base support plate.

In an embodiment one or more gussets 19 may be between the horizontal portion and the existing base support plate. In some instances, gussets may be required to resist uplift and reduce deflection.

The system may further provide an option for two anchoring plates positioned on opposite sides of the column 13, thereby enhancing the stability of the overall assembly. In situations where such positioning is required, the various plates may be adjusted to reflect the existing offsets in hardware or structures.

The horizontal portion 17 is also designed with utility in mind, featuring pre-drilled holes 33 for efficient attachment to the existing base support plate 21. Additionally, considerations for safety and functionality lead to designing the corners of the horizontal portion for beveled or curved profiles, minimizing any potential hazards during everyday operations.

Importantly, this replacement anchoring plate system is envisioned also to be employed within anchoring guards 37, providing a multi-layered protection solution for the entire anchoring assembly. While the typical utilization of the anchoring plate may occur in an exposed manner, its design allows for integration when anchoring guards are present.

Furthermore, the system, when used within an anchoring guard, may be outfitted with one or two anchoring plates, each situated within the perimeter 41 of the anchor guard 37. This adaptability allows for cases where existing protections are either present or need to be reinforced.

The versatility of the replacement anchoring plate system enhances its application across various warehouse environments. Users may easily replace damaged anchoring hardware without requiring extensive downtime or complex installation procedures. The system is designed to accommodate different shapes and sizes of columns and base plates, which may vary significantly based on the warehouse design.

In terms of materials, the replacement anchoring plates 5 may be fabricated from high-strength steel or similar durable materials that resist bending and shearing under impact. This ensures that the structural resilience of the plates matches or exceeds that of the original anchoring hardware, thereby enhancing the overall durability of the storage rack system. Hot rolling or cold rolling processes may be used to fabricate the plates.

Additionally, the provisions for one or more anchoring shims not only facilitate customizable height adjustment but also enable the user to address uneven flooring issues commonly found in older warehouse infrastructures. The shim's thickness may be designed to precisely match the dimensions of the replaced hardware, ensuring a flush and secure fit.

In practice, the replacement anchoring plate system would be installed as follows: Upon identifying damaged anchoring hardware 49, users would first remove any remaining compromised components. Next, the suitable replacement anchoring plate 5 would be aligned properly with the vertical column 13 and the existing base plate 21 Utilizing the pre-drilled holes 33 in both the perpendicular and horizontal portions, anchoring screws or bolts 31 are inserted securely, guaranteeing a robust connection.

One aspect of the present disclosure is directed to a replacement anchoring plate system for storage rack systems. The system includes a replacement anchoring plate. The replacement anchoring plate includes a substantially perpendicular portion configured to be fixed to a lower portion of a column; and a horizontal portion attached to the substantially perpendicular portion. The horizontal portion extends over at least a portion of an existing base support plate.

In one embodiment, the substantially perpendicular portion is anchored directly to the column.

In another embodiment, the replacement anchoring plate system includes an anchoring shim. The anchoring shim is between the substantially perpendicular portion and the column, and the substantially perpendicular portion is anchored to the column through the anchoring shim.

In another embodiment, the thickness of the anchoring shim is the same as the thickness of the substantially perpendicular portion.

In another embodiment, there are two replacement anchoring plates, and the two replacement anchoring plates are on opposite sides of the column.

In another embodiment, the substantially perpendicular portion of one of the two replacement anchoring plates is anchored directly to the column; and the substantially perpendicular portion of the other replacement anchoring plate is either anchored to the column through an anchoring shim or is anchored directly to the column.

In another embodiment, one or more gussets are between the horizontal portion and the existing base support plate.

In another embodiment, the replacement anchoring plate system includes an anchoring shim. The anchoring shim is between the horizontal portion and at least a portion of the existing base support plate.

In another embodiment, the thickness of the anchoring shim is the same as the thickness of the horizontal portion.

In another embodiment, the substantially perpendicular portion has one or more pre-drilled holes for attachment to the column.

In another embodiment, the horizontal portion has plural pre-drilled holes for attachment to at least a portion of the existing base support plate.

In another embodiment, the corners of the horizontal portion are beveled or curved.

In another embodiment, at least a portion of the perimeter of the horizontal portion is within the perimeter of the existing base support plate.

In another embodiment, at least a portion of the perimeter of the horizontal portion is outside the perimeter of the existing base support plate.

In another embodiment, the replacement anchoring plate system is used within an anchor guard. And the horizontal portion is within the perimeter of the anchor guard.

In another embodiment, in which the replacement anchoring plate system is used within an anchor guard, there are one or two replacement anchoring plates, and each of the one or two horizontal portions is within the perimeter of the anchor guard.

In another embodiment, in which the replacement anchoring plate system is used within an anchor guard, there are two replacement anchoring plates, and the two replacement anchoring plates are on opposite sides of the column.

Another aspect of the present disclosure is directed to a replacement anchoring plate system for storage rack systems. The replacement anchoring plate system includes a replacement anchoring plate. The replacement anchoring plate includes a substantially perpendicular portion configured to be fixed to a lower portion of a column; and a horizontal portion attached to the substantially perpendicular portion. The horizontal portion extends over at least a portion of an existing base support plate. The replacement anchoring plate system also includes a first anchoring shim, in which the first anchoring shim is between the horizontal portion and at least a portion of the existing base support plate.

In one embodiment, the replacement anchoring plate system includes a second anchoring shim. And the second anchoring shim is between the substantially perpendicular portion and the column, and the substantially perpendicular portion is anchored to the column through the second anchoring shim.

In another embodiment, the thickness of the first anchoring shim is the same as the thickness of the horizontal portion, and the thickness of the second anchoring shim is the same as the thickness of the substantially perpendicular portion.

With the potential for high turnover rates in a warehouse environment, the aesthetic design of the plates may also be considered for branding or visibility, allowing users to choose colors that align with their safety protocols and operational branding.

The terms “a,” “an,” “the” and similar referents used in the context of describing the invention (especially in the context of the following claims) are to be construed to cover both the singular and the plural, unless otherwise indicated herein or clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Certain embodiments of this invention are described herein, including the best mode known to the inventor for carrying out the invention. Of course, variations on these described embodiments will become apparent to those of ordinary skill in the art upon reading the foregoing description. The inventor expects skilled artisans to employ such variations as appropriate, and the inventor intends for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and inventive characteristic(s). Embodiments of the invention so claimed are inherently or expressly described and enabled herein.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A replacement anchoring plate system for storage rack systems comprising:
a replacement anchoring plate, wherein the replacement anchoring plate comprises:
a substantially perpendicular portion configured to be fixed to a lower portion of a column; and
a horizontal portion attached to the substantially perpendicular portion, wherein the horizontal portion extends over at least a portion of an existing base support plate.

2. The replacement anchoring plate system of claim 1, wherein the substantially perpendicular portion is anchored directly to the column.

3. The replacement anchoring plate system of claim 1, further comprising an anchoring shim, wherein the anchoring shim is between the substantially perpendicular portion and the column, and wherein the substantially perpendicular portion is anchored to the column through the anchoring shim.

4. The replacement anchoring plate system of claim 3, wherein the thickness of the anchoring shim is the same as the thickness of the substantially perpendicular portion.

5. The replacement anchoring plate system of claim 1, wherein there are two replacement anchoring plates, and wherein the two replacement anchoring plates are on opposite sides of the column.

6. The replacement anchoring plate system of claim 5, wherein the substantially perpendicular portion of one of the two replacement anchoring plates is anchored directly to the column; and the substantially perpendicular portion of the other replacement anchoring plate is anchored to the column through an anchoring shim or is anchored directly to the column.

7. The replacement anchoring plate system of claim 1, wherein one or more gussets are between the horizontal portion and the existing base support plate.

8. The replacement anchoring plate system of claim 1, further comprising an anchoring shim, wherein the anchoring shim is between the horizontal portion and at least a portion of the existing base support plate.

9. The replacement anchoring plate system of claim 8, wherein the thickness of the anchoring shim is the same as the thickness of the horizontal portion.

10. The replacement anchoring plate system of claim 1, wherein the substantially perpendicular portion has one or more pre-drilled holes for attachment to the column.

11. The replacement anchoring plate system of claim 1, wherein the horizontal portion has plural pre-drilled holes for attachment to at least a portion of the existing base support plate.

12. The replacement anchoring plate system of claim 1, wherein the corners of the horizontal portion are beveled or curved.

13. The replacement anchoring plate system of claim 1, wherein at least a portion of the perimeter of the horizontal portion is within the perimeter of the existing base support plate.

14. The replacement anchoring plate system of claim 1, wherein at least a portion of the perimeter of the horizontal portion is outside the perimeter of the existing base support plate.

15. The replacement anchoring plate system of claim 1, for use in an anchor guard, wherein the horizontal portion is within the perimeter of the anchor guard.

16. The replacement anchoring plate system of claim 1, for use in an anchor guard, wherein there are one or two replacement anchoring plates, and wherein each of the one or two horizontal portions is within the perimeter of the anchor guard.

17. The replacement anchoring plate system of claim 16, wherein there are two replacement anchoring plates, and wherein the two replacement anchoring plates are on opposite sides of the column.

18. A replacement anchoring plate system for storage rack systems comprising:
a replacement anchoring plate, wherein the replacement anchoring plate comprises:
a substantially perpendicular portion configured to be fixed to a lower portion of a column;
a horizontal portion attached to the substantially perpendicular portion, wherein the horizontal portion extends over at least a portion of an existing base support plate; and
a first anchoring shim, wherein the first anchoring shim is between the horizontal portion and at least a portion of the existing base support plate.

19. The replacement anchoring plate system of claim 18, further comprising a second anchoring shim, wherein the second anchoring shim is between the substantially perpendicular portion and the column, and wherein the substantially perpendicular portion is anchored to the column through the second anchoring shim.

20. The replacement anchoring plate system of claim 19, wherein the thickness of the first anchoring shim is the same as the thickness of the horizontal portion, and wherein the thickness of the second anchoring shim is the same as the thickness of the substantially perpendicular portion.
